(19) United States
(12) Patent Application Publication
(10) Pub. No.: US 2023/0406393 A1
(43) Pub. Date: Dec. 21, 2023

(54) Heatable Steering Wheel Cover

(71) Applicant: NINGHAI RABBIT AUTOMOTIVE PRODUCTS CO., LTD., Ningbo (CN)

(72) Inventor: Jiangqiang You, Ningbo (CN)

(21) Appl. No.: 17/846,005

(22) Filed: Jun. 21, 2022

(30) Foreign Application Priority Data
May 20, 2022 (CN) 202221238183.7

(51) Int. Cl. B62D 1/06; H05B 3/20; H05B 1/02

(52) U.S. Cl. CPC B62D 1/065; H05B 3/20; H05B 2203/013; H05B 2214/04; H05B 1/0236

(57) ABSTRACT

A heatable steering wheel cover includes an outer cover, a magnetically attractive charging connector, a steering wheel cover framework and a first heating sheet. The steering wheel cover framework is configured for being connected with a steering wheel, the outer cover wraps a surface of the steering wheel cover framework, and the first heating sheet is fixedly mounted in a gap between the steering wheel cover framework and the outer cover, and the magnetically attractive charging connector is electrically connected to the first heating sheet, and a charging end of the magnetically attractive charging connector is exposed to the outside relative to a surface of the outer cover. The heatable steering wheel cover is externally connected to a power supply interface in a magnetically attractive manner via a magnetically attractive charging connector additionally provided on the steering wheel cover.

### CROSS REFERENCE TO RELATED APPLICATIONS

The present application claims the benefit of Chinese Patent Application No. 202221238183.7 filed on May 20, 2022, the contents of which are incorporated herein by reference in their entirety.

### FIELD OF THE INVENTION

The present application relates to the technical field of steering wheel covers, and in particular to a heatable steering wheel cover.

### BACKGROUND OF THE INVENTION

Most of the vehicle owners who treasure their vehicles prefer to wrap a steering wheel in a steering wheel cover for protecting the steering wheel. In order to improve the practicability of the steering wheel cover, there is a kind of steering wheel cover having a heating function on the market, which is externally connected to a power supply interface on a vehicle. However, the power supply to most of the existing heatable-type steering wheel covers would function in two manners. One is to form a charging line extending from the steering wheel cover, and the other is to provide a socket on the steering wheel cover, which is connected with a power supply interface via a socket charging line. The interfaces in the above-mentioned two solutions cannot be easily disconnected, and thus, when the steering wheel is rapidly turned, it is prone to causing wire winding, affecting driving.

### SUMMARY OF THE INVENTION

The application aims to solve one of the technical problems in the related art at least to a certain extent. Therefore, the application provides a heatable steering wheel cover, which is externally connected to a power supply interface in a magnetically attractive manner via a magnetically attractive charging connector additionally provided on the steering wheel cover. The magnetically attractive charging connector can be easily disconnected, which is not prone to causing wire winding.

The technical solution adopted in the application is to provide a heatable steering wheel cover, including an outer cover, a magnetically attractive charging connector, a steering wheel cover framework and a first heating sheet, wherein the steering wheel cover framework is configured for being connected with a steering wheel, wherein the outer cover wraps a surface of the steering wheel cover framework, and the first heating sheet is fixedly mounted in a gap between the steering wheel cover framework and the outer cover, and wherein the magnetically attractive charging connector is electrically connected to the first heating sheet, and a charging end of the magnetically attractive charging connector is exposed to the outside relative to a surface of the outer cover.

By using the above structure, the magnetically attractive charging connector is externally connected to a power supply interface in a magnetically attractive manner, so as to supply power to the first heating sheet. The heat generated by the operation of the first heating sheet radiates to the surface of the outer cover, so as to facilitate the transfer of the heat to gripping palms of a driver, thereby improving the driving experience. The magnetically attractive charging connector can be easily disconnected in time by being externally connected to the power supply interface in the magnetically attractive manner, which is not prone to causing wire winding.

According to one embodiment of the application, the steering wheel cover framework has two wrapping sides, wherein an annular opening for entry of the steering wheel is formed between edges of the two wrapping sides, and the outer cover has inner wrapping sides for wrapping the wrapping sides. The steering wheel cover framework as a whole has a certain toughness, so as to facilitate being connected with the steering wheel in a sleeving manner. A clamping gap for clamping the steering wheel is formed between the wrapping sides, and the provision of the inner wrapping sides avoids the exposure of the edges of the wrapping sides, thereby improving the aesthetics feeling of the heatable steering wheel cover.

According to one embodiment of the application, all or part of a surface of the wrapping sides is provided with a circuit groove. The circuit groove is provided in the wrapping sides, for the one is to avoid the heat generated by the first heating sheet from directly radiating to an electrical connection cable in the circuit groove and affecting the service life of the electrical connection cable, and the other is due to that the wrapping sides do not fit the palms of the driver during being normal clamped and to avoid the concave-convex touch caused by the burying of the electrical connection cable.

According to one embodiment of the application, the heatable steering wheel cover further includes a second heating sheet. The second heating sheet is fixedly mounted in the gap between the steering wheel cover framework and the outer cover, and the second heating sheet is electrically connected to the magnetically attractive charging connector.

According to one embodiment of the application, a fitting face of the steering wheel cover framework against the first heating sheet and/or the second heating sheet is a plane or a convex surface that curves outwardly. The fitting face is selected and configured in view of the softness of the material of the first heating sheet and/or the second heating sheet.

According to one embodiment of the application, the first heating sheet and/or the second heating sheet is a far-infrared electrothermal film.

According to one embodiment of the application, the first heating sheet and/or the second heating sheet is a graphene electrothermal film.

According to one embodiment of the application, the outer cover or the steering wheel cover framework is provided with a Bluetooth control module, which is wirelessly connected with a mobile communication device via Bluetooth.

According to one embodiment of the application, the Bluetooth control module is detachably mounted on the outer cover or the steering wheel cover framework, and a mobile power supply unit is provided inside the Bluetooth control module.

According to one embodiment of the application, the Bluetooth control module is electrically connected to the magnetically attractive charging connector.

### BRIEF DESCRIPTION OF THE DRAWINGS

FIG. 1 is a structural schematic diagram of a steering wheel cover in an embodiment of the application;

FIG. 2 is a sectional view along line A-A in FIG. 1;

FIG. 3 is a partially enlarged view at “B” in FIG. 2;

FIG. 4 is a partially enlarged view at “C” in FIG. 2;

FIG. 5 is an exploded view of a steering wheel cover in an embodiment of the application;

FIG. 6 is an exploded view of the space between an outer cover, and a first heating sheet and a second heating sheet in an embodiment of the application;

FIG. 7 is a structural schematic diagram of the outer cover in an embodiment of the application; and

FIG. 8 is a structural schematic diagram of an outer cover in another embodiment of the application.

### DESCRIPTION OF REFERENCE NUMERALS IN THE FIGURES

1. Outer cover; 2. Magnetically attractive charging connector; 3. Steering wheel cover framework; 4. First heating sheet; 5. Second heating sheet; 6. Bluetooth control module;
11. Inner wrapping side;
31. Wrapping side; 32. Fitting face; and 33. Circuit groove.

### DETAILED DESCRIPTION OF THE EMBODIMENTS

Embodiments of the application will be described in detail below. Examples of the embodiments are shown in the accompanying drawings, and throughout the drawings, the same or similar reference numerals refer to the same or similar elements or elements having the same or similar functions. The embodiments described below with reference to the accompanying drawings are exemplary and are merely intended to illustrate the application, but should not be interpreted as a limit on the application.

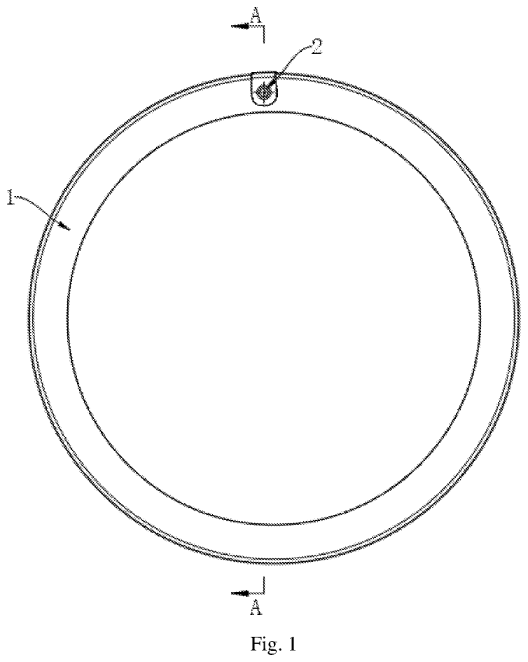

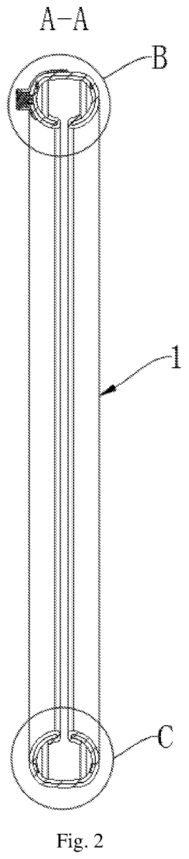

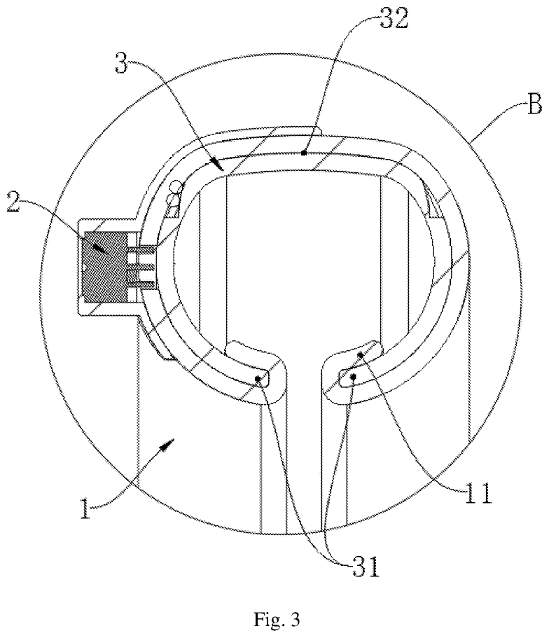

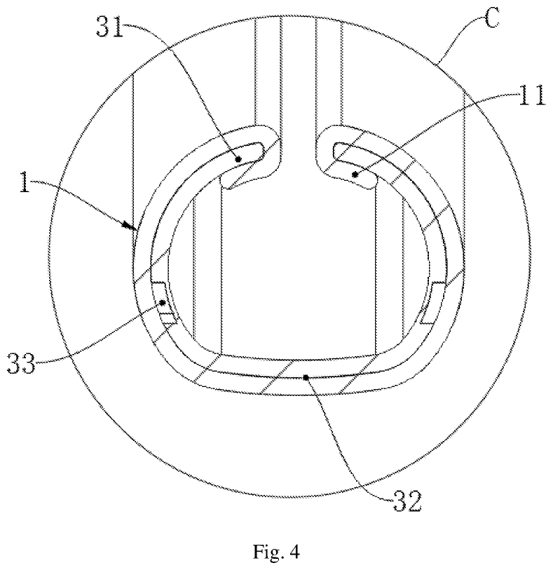

As shown in FIGS. 1-4, this embodiment provides a heatable steering wheel cover including an outer cover 1, a magnetically attractive charging connector 2, a steering wheel cover framework 3 and a first heating sheet 4. The steering wheel cover framework 3 is configured for being connected with a steering wheel. The outer cover 1 wraps a surface of the steering wheel cover framework 3, and the first heating sheet 4 is fixedly mounted in a gap between the steering wheel cover framework 3 and the outer cover 1. The magnetically attractive charging connector 2 is electrically connected to the first heating sheet 4, and a charging end of the magnetically attractive charging connector 2 is exposed to the outside relative to a surface of the outer cover 1.

Furthermore, in this embodiment, the steering wheel cover framework 3 is connected to a surface of a steering wheel in a sleeving manner. The outer cover 1 covers the surface of the steering wheel cover framework 3 for a driver to touch.

Still further, in this embodiment, the outer cover 1 is made of a skin-friendly material, such as leather.

Furthermore, in this embodiment, the magnetically attractive charging connector 2 is externally connected to the power supply interface in a magnetically attractive manner. When the steering wheel is rapidly turned, the magnetically attractive connection position is subjected to force and can be easily disconnected, and thus, it is not prone to causing wire winding.

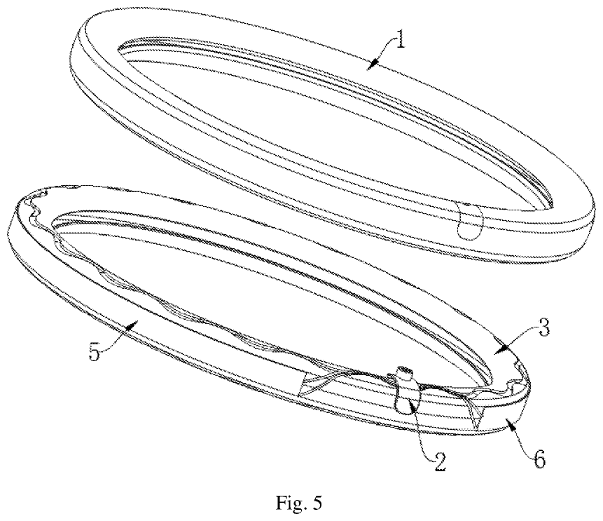

Specifically, in combination with FIG. 5, the steering wheel cover framework 3 has two wrapping sides 31, wherein an annular opening for entry of the steering wheel is formed between edges of the two wrapping sides 31, and the outer cover 1 has inner wrapping sides 11 for wrapping the wrapping sides 31.

Furthermore, in this embodiment, the steering wheel cover as whole is connected to the steering wheel in a sleeving manner, and the steering wheel cover as whole needs to have a certain toughness, wherein one wrapping side 31 is configured for clamping one side of the steering wheel that faces the driver, and the other wrapping side 31 is configured for clamping one side of the steering wheel that is away from the driver.

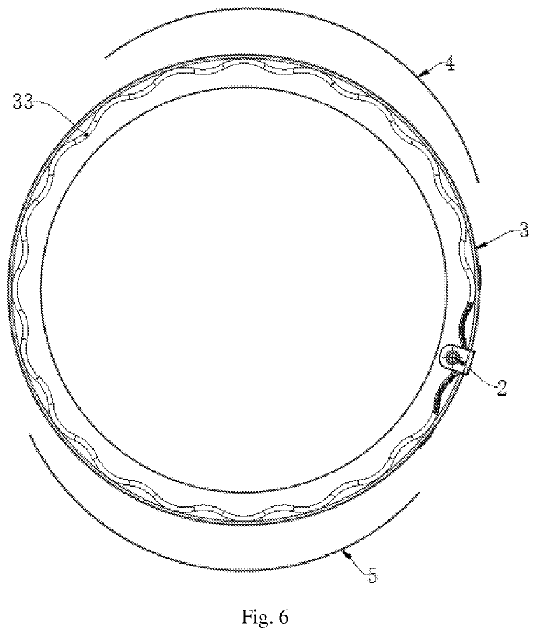

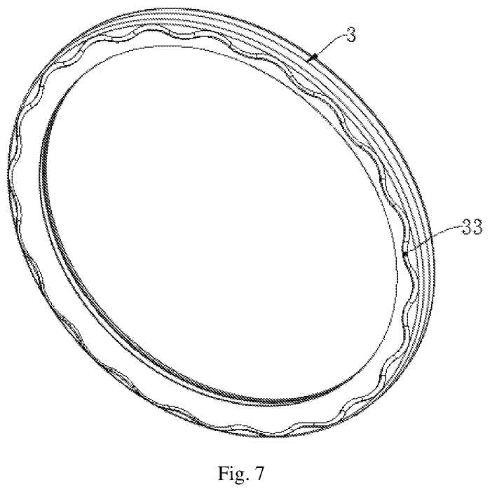

Specifically, in combination with FIG. 6 and FIG. 7, all or part of a surface of the wrapping sides 31 is provided with a circuit groove 33, that is, the surfaces of two or any one of the wrapping sides 31 are/is provided with the circuit groove 33.

Furthermore, In this embodiment, the circuit groove 33 is provided in the wrapping side 31 on the side of the steering wheel that is away from the driver, for the one is to avoid the heat generated by the first heating sheet 4 from directly radiating to an electrical connection cable in the circuit groove 33 and affecting the service life of the electrical connection cable, and the other is due to that the wrapping sides do not fit the palms of the driver during being normal clamped and to avoid the concave-convex touch caused by the burying of the electrical connection cable.

Still further, in this embodiment, the magnetically attractive charging connector 2 is provided on the side of the steering wheel that is away from the driver, so as to facilitate being externally connected to the power supply interface.

Specifically, the heatable steering wheel cover further includes a second heating sheet 5. The second heating sheet 5 is fixedly mounted in the gap between the steering wheel cover framework 3 and the outer cover 1, and the second heating sheet 5 is electrically connected to the magnetically attractive charging connector 2.

Furthermore, when the steering wheel is returned, the steering wheel has two gripping ranges. In this embodiment, the first heating sheet 4 covers an edge of one of the gripping ranges, and the second heating sheet 5 covers an edge of the other one of the gripping ranges.

Specifically, a fitting face 32 of the steering wheel cover framework 3 against the first heating sheet 4 and/or the second heating sheet 5 is a plane or a convex surface that curves outwardly.

Specifically, the first heating sheet 4 and/or the second heating sheet 5 is a far-infrared electrothermal film.

Furthermore, in this embodiment, the first heating sheet 4 and the second heating sheet 5 are both far-infrared electrothermal films.

Still further, the first heating sheet 4 and/or the second heating sheet 5 is a graphene electrothermal film.

Furthermore, in this embodiment, the first heating sheet 4 and second heating sheet 5 are both graphene electrothermal films.

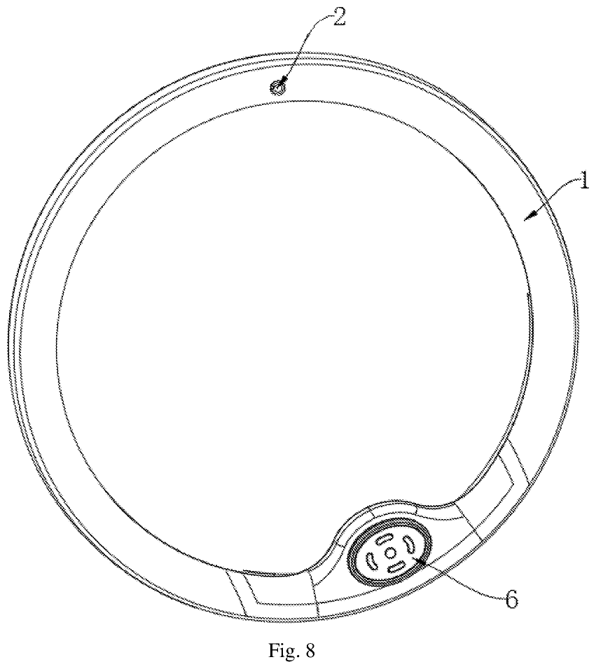

Specifically, in combination with FIG. 8, in another embodiment, the outer cover 1 or the steering wheel cover framework 3 is provided with a Bluetooth control module 6, which is wirelessly connected with a mobile communication device via Bluetooth.

Furthermore, in another embodiment, the mobile communication device is a mobile phone or a tablet computer, and the Bluetooth control module 6 can be connected via Bluetooth and manipulate the mobile phone or the tablet computer to play or switch music, adjust the volume, answer or make a call, etc.

Specifically, the Bluetooth control module 6 is detachably mounted on the outer cover 1 or the steering wheel cover framework 3, and a mobile power supply unit is provided inside the Bluetooth control module 6.

Furthermore, the whole body formed by the outer cover 1 and the steering wheel cover framework 3 has a structure for the mounting of the Bluetooth control module 6. When a surface of the Bluetooth control module 6 is in direct contact with the outer cover 1, the Bluetooth control module 6 is mounted on the outer cover 1; and when the surface of the Bluetooth control module 6 is in direct contact with the steering wheel cover framework 3, the Bluetooth control module 6 is mounted on the steering wheel cover framework 3.

Furthermore, in another embodiment, the mobile power supply unit is a battery, which can supply power to a detached Bluetooth control module 6.

Specifically, the Bluetooth control module 6 is electrically connected to the magnetically attractive charging connector 2.

Furthermore, in another embodiment, the Bluetooth control module 6 is fixedly mounted on the steering wheel cover framework 3, and the magnetically attractive charging connector 2 is externally connected to a power supply interface to directly supply power to the Bluetooth control module 6.

In the description of the application, it should be understood that the orientation or positional relationships indicated by the terms “center”, “longitudinal”, “transverse”, “length”, “width”, “thickness”, “upper”, “lower”, “front”; “rear”, “left”, “right”, “vertical”, “horizontal”, “top”, “bottom”, “inside”, “outside”, “clockwise”, “counter-clockwise”, “axial direction”, “radial direction”, “circumferential direction”, etc. are based on the orientation or positional relationship shown in the accompanying drawings and are only for facilitating the description of the application and simplifying the description, rather than indicating or implying that the device or element referred to must have a particular orientation or be constructed and operated in a particular orientation, and therefore will not be interpreted as a limit to the application.

In addition, the terms “first” and “second” are for descriptive purposes only and should not be interpreted as indicating or implying relative importance or implicitly indicating the number of technical features indicated. Thus, features defined with “first” and “second” may explicitly or implicitly include at least one of the features. In the description of the application, “a plurality of” means at least two, for example, two, three, etc., unless specifically defined otherwise.

In the application, unless otherwise explicitly specified and defined, terms “mounting”, “connecting”, “connection”, “fixing”, etc. should be understood in a broad sense, for example, they can be a fixed connection, a detachable connection, or an integrated connection; may be a mechanical connection, or an electrical connection or mutual communication; and may be a direct connection, or an indirect connection via an intermediate medium, or communication between the interiors of two elements or the interaction of two elements, unless explicitly specified otherwise. A person of ordinary skill in the art may understand the specific meanings of the foregoing terms in the application according to specific circumstances.

Although the embodiments of the application have been shown and described above, it should be understood that the above-mentioned embodiments are merely exemplary and should not be interpreted as a limit to the application. A person of ordinary skill in the art may make changes, modifications, replacements and variations to the above-mentioned embodiments within the scope of the application.

1. A heatable steering wheel cover, comprising an outer cover (1), a magnetically attractive charging connector (2), a steering wheel cover framework (3) and a first heating sheet (4), wherein the steering wheel cover framework (3) is configured for being connected with a steering wheel, wherein the outer cover (1) wraps a surface of the steering wheel cover framework (3), and the first heating sheet (4) is fixedly mounted in a gap between the steering wheel cover framework (3) and the outer cover (1), and wherein the magnetically attractive charging connector (2) is electrically connected to the first heating sheet (4), and a charging end of the magnetically attractive charging connector (2) is exposed to an outside relative to a surface of the outer cover (1).

2. The heatable steering wheel cover according to claim 1, wherein the steering wheel cover framework (3) has two wrapping sides (31), wherein an annular opening for entry of the steering wheel is formed between edges of the two wrapping sides (31), and the outer cover (1) has inner wrapping sides (11) for wrapping the wrapping sides (31).

3. The heatable steering wheel cover according to claim 2, wherein all or part of a surface of the wrapping sides (31) is provided with a circuit groove (33).

4. The heatable steering wheel cover according to claim 1, further comprising a second heating sheet (5), wherein the second heating sheet (5) is fixedly mounted in the gap between the steering wheel cover framework (3) and the outer cover (1), and the second heating sheet (5) is electrically connected to the magnetically attractive charging connector (2).

5. The heatable steering wheel cover according to claim 4, wherein a fitting face (32) of the steering wheel cover framework (3) against the first heating sheet (4) and/or the second heating sheet (5) is a plane or a convex surface that curves outwardly.

6. The heatable steering wheel cover according to claim 5, wherein the first heating sheet (4) and/or the second heating sheet (5) is a far-infrared electrothermal film.

7. The heatable steering wheel cover according to claim 5, wherein the first heating sheet (4) and/or the second heating sheet (5) is a graphene electrothermal film.

8. The heatable steering wheel cover according to claim 1, wherein the outer cover (1) or the steering wheel cover framework (3) is provided with a Bluetooth control module (6), which is wirelessly connected with a mobile communication device via Bluetooth.

9. The heatable steering wheel cover according to claim 8, wherein the Bluetooth control module (6) is detachably mounted on the outer cover (1) or the steering wheel cover framework (3), and a mobile power supply unit is provided inside the Bluetooth control module (6).

10. The heatable steering wheel cover according to claim 8, wherein the Bluetooth control module (6) is electrically connected to the magnetically attractive charging connector (2).
